(19) United States
(12) Patent Application Publication
(10) Pub. No.: US 2022/0062999 A1
(43) Pub. Date: Mar. 3, 2022

(54) POWDERED BUILD MATERIAL DISTRIBUTION

(71) Applicant: Hewlett-Packard Development Company, L.P., Spring, TX (US)

(72) Inventors: Chris Paul Schodin, San Diego, CA (US); Krzyaztof Nauki, Palo Alto, CA (US)

(73) Assignee: Hewlett-Packard Development Company, L.P., Spring, TX (US)

(21) Appl. No.: 17/414,568

(22) PCT Filed: May 22, 2019
(86) PCT No.: PCT/US2019/033483

§ 371 Date: Jun. 16, 2021

(51) Int. Cl. B22F 12/53; B22F 12/13; B22F 10/14; B29C 64/165; B29C 64/209; B29C 64/255; B29C 64/295; B33Y 10/00; B33Y 30/00; B33Y 40/00

(52) U.S. Cl. CPC B22F 12/53; B22F 12/13; B22F 10/14; B29C 64/165; B33Y 40/00; B29C 64/255; B29C 64/295; B33Y 10/00; B33Y 30/00; B29C 64/209

(57) ABSTRACT

In one example in accordance with the present disclosure, a build material distribution device is described. The build material distribution device includes a pressurized container to hold a suspension of a powdered build material in a liquid carrier. The powdered build material is to form a three-dimensional (3D) printed part. The build material distribution device also includes a nozzle through which the suspension is ejected and a pressurizer coupled to the pressurized container to eject the suspension through the nozzle.

### BACKGROUND

Additive manufacturing systems produce three-dimensional (3D) objects by building up layers of material. Some additive manufacturing systems are referred to as “3D printing devices” because they use inkjet or other printing technology to apply some of the manufacturing materials. 3D printing devices and other additive manufacturing devices make it possible to convert a computer-aided design (CAD) model or other digital representation of an object directly into the physical object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a build material distribution device, according to an example of the principles described herein.

FIG. 2 is a simplified top view of an additive manufacturing system for build material distribution, according to an example of the principles described herein.

FIG. 3 is an isometric view of a build material distribution device, according to an example of the principles described herein.

FIG. 4 is a flow chart of a method for build material distribution, according to an example of the principles described herein.

FIG. 5 is a diagram for build material distribution, according to an example of the principles described herein.

FIG. 6 is a diagram of the ejection of powdered build material distribution, according to an example of the principles described herein.

FIG. 7 is a diagram of a pressurized container in a build material distribution device, according to an example of the principles described herein.

FIG. 8 is a flow chart of a method for build material distribution, according to another example of the principles described herein.

FIG. 9 is a diagram of a breakup of jetted suspension, according to an example of the principles described herein.

FIG. 10 is a diagram of a spray pattern, according to an example of the principles described herein.

FIGS. 11A-11H are Reitz diagrams of various ejection characteristics, according to examples of the principles described herein.

FIGS. 12A-12D are graphs of spray assembly velocities, according to examples of the principles described herein.

FIGS. 13A and 13B are diagrams of average spray droplet sizes for various spray generation conditions, according to examples of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Additive manufacturing systems make a three-dimensional (3D) object through the solidification of layers of a build material. Additive manufacturing systems make objects based on data in a 3D model of the object generated, for example, with a computer-aided drafting (CAD) computer program product. The model data is processed into slices, each slice defining portions of a layer of build material that is to be solidified.

In one, example, to form the 3D object, a build material, which may be powder, is deposited on a bed. A fusing agent is then dispensed onto portions of the layer of build material that are to be fused to form a layer of the 3D object. The system that carries out this type of additive manufacturing may be referred to as a powder and fusing agent-based system. The fusing agent disposed in the desired pattern increases the energy absorption of the underlying layer of build material on which the agent is disposed. The build material is then exposed to energy such as electromagnetic radiation. The electromagnetic radiation may include infrared light, laser light, or other suitable electromagnetic radiation. Due to the increased heat absorption properties imparted by the fusing agent, those portions of the build material that have the fusing agent disposed thereon heat to a temperature greater than the fusing temperature for the build material.

Another way of 3D printing is with help of selectively applied binder which glues particles together. In this example, a “green” part is prepared by selectively applying binder to powdered build material. The green part is then removed from the printer and loaded into a sintering furnace. Sintering with gradually increasing temperature and using appropriate ambient pressure burns out the binder while simultaneously sintering particles with binder disposed thereon.

In yet another example, a laser, or other power source is selectively aimed at a powder build material, or a layer of a powder build material, to form a slice of a 3D printed part. Such a process may be referred to as selective laser sintering. In yet another example, the additive manufacturing process may be selective laser melting where portions of the powder material, which may be metallic, are selectively melted together to form a slice of a 3D printed part.

While such additive manufacturing operations have greatly expanded manufacturing and development possibilities, further development may make such 3D printed parts even more accurate and may therefore make the 3D printing process even more practical. For example, it may be desirable to deposit very thin layers of powder material so as to increase the resolution of the resulting part. In general, the deposition of thin layers of a powdered build material may be prohibitively complex. For example, in general powdered build material particles are deposited on the surface of a previously processed layer by a mechanical dispenser. After such deposition, the recently deposited, but not fused, layer may be uniformly spread and thinned via a mechanical blade or a roller. Such a spreading operation involves mechanical displacement of individual powder particles with respect to each other. As long as the friction forces between the particles is smaller than the mechanical displacement and gravity forces, such an operation may be effective.

However, build material made up of small particles having rough surfaces may be more difficult to spread as a thin layer. For example, 1) attractive Van der Waals forces originating from distorted surface bonds on particle surfaces and 2) friction between adjacent particles that are moved by a mechanical device may exceed the mechanical locking forces. This can lead to localized and uncontrolled agglomeration of particles, which makes spreading uniformly thick layers very difficult. That is, as small and potentially irregularly shaped particles are acted upon by a mechanical leveling device, they may clump together resulting in imperfections on the surface of the build material and potentially disrupting already formed layers. This is particularly apparent in cases of metal or ceramic 3D printing which often involves the deposition of particles that are less than 20 micrometers in diameter and in layers that are less than 50 micrometers thick.

Forming such thin layers is also complicated due to the interaction of the currently deposited layer with underlying layers. That is, mechanical devices such as rollers and blades that spread powder on the surface of a previously deposited layer can damage this previously deposited layer. For example, newly deposited particles may interact with particles of a previously deposited, and fused, layer and may pull and drag them from their positions, thus disrupting the packing of the underlying powder.

Using a mechanical leveling device may impact the additive manufacturing operation in other ways. For example, particles just deposited may cling to the surface of a mechanical device thus introducing surface imperfections in a recently smoothed surface. Moreover, vibration of the mechanical device that smooths the layer can impinge on the underlying powder film. Either of these situations disturbs the surface of the build material, which can affect print quality. Accordingly, additive manufacturing devices that rely on mechanical smoothing and/or leveling may not be able to produce powdered material layers of less than 50 micrometers. Moreover, the use of such mechanical spreading devices may also introduce layer thickness errors as large as 10-30 micrometers. Even further, such material spreading systems may make it very difficult to apply more than one material. For example, it may be difficult to form a thin layer of a material A surrounded by a material B.

Accordingly, the present specification describes systems and methods that result in uniform and thin layers of powdered build material. Specifically, the present specification describes a build material distribution device and method that eliminates physical contact between the deposition hardware and previously deposited particles. The system also minimizes interactions between adjacent particles. To do so, the powder material distribution device sprays a liquid suspension of particles on a substrate, which substrate may be a previously deposited layer of particles.

Specifically, the present specification describes a build material distribution device. The distribution device includes a rotating pressurized container to hold a suspension of a powdered build material in a liquid carrier. In this example, the powdered build material is to form a three-dimensional (3D) printed part. The distribution device also includes a nozzle through which the suspension is ejected. A pressurizer of the distribution device is coupled to the rotating pressurized container and ejects the suspension through the nozzle.

The present specification also describes a method. According to the method, a suspension of a powdered build material in a liquid carrier is introduced into a pressurized container. A pressure within the pressurized container is adjusted to eject the suspension through a nozzle. A scanning carriage on which the pressurized container is disposed is moved to deposit a layer of the suspension.

The present specification also describes, an additive manufacturing system that includes a build material distribution device. The build material distribution device includes a pressurized container to hold a suspension of a powdered build material in a liquid carrier. The build material distribution device also includes a nozzle through which the suspension is ejected and a pressurizer coupled to the pressurized container to eject the suspension through the nozzle. In this example, the build material distribution device also includes a disruptor disposed within at least one of the pressurized container and the nozzle to introduce turbulence to the suspension. The additive manufacturing system also includes an agent distributor to selectively apply a solidifying agent to a layer of powdered build material to form a three-dimensional (3D) printed object and a controller to adjust operation of the build material distribution device and the agent distributor to print the 3D printed object.

Such systems and methods 1) perform precise and controlled deposition of a layer of build material, in some cases less than 50 micrometers thin and can do so at a rate of a few tens of centimeters per second; 2) facilitates reliable formation of thin powder films used in 3D printing; 3) can deposit small amounts of particles, small-sized particles and/or non-uniform particles; 4) increases part resolution by reducing interactions between a previously deposited layer and a currently deposited layer; and 5) reduces part cost by using low-cost, small particles that are irregularly shaped and may not otherwise be usable in 3D printing operations. However, it is contemplated that the devices disclosed herein may address other matters and deficiencies in a number of technical areas.

Note that while specific reference is made to additive manufacturing, the present deposition device may be used in other industries as well and may used to deposit any type of material including plastics, metals, or ceramics.

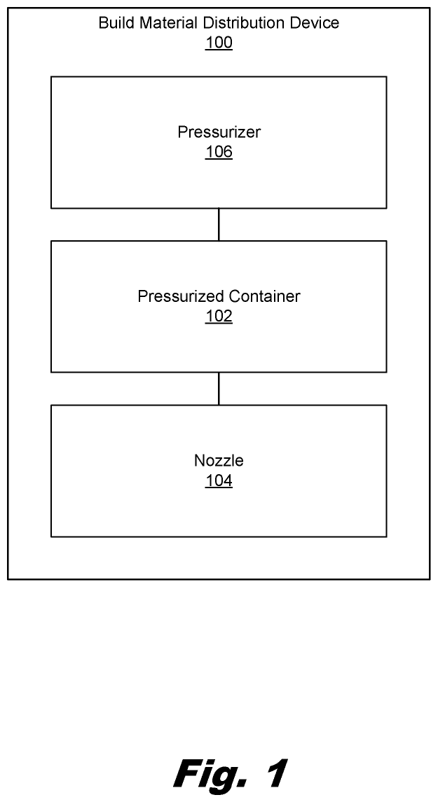

Turning now to the figures, FIG. 1 is a block diagram of a build material distribution device (100), according to an example of the principles described herein. As used in the present specification and in the appended claims, the term “powdered build material” or “build material” is meant to refer to any form of particulate material and may include various types of material including plastic, metal, and ceramic. As described above, it may be desirable to use small particles, on the order of less than 20 micrometers in diameter, as it allows for a higher resolution 3D printed part. Moreover, it may be desirable to form thin layers, less than 50 micrometers thick, again to increase the resolution of the resulting 3D printed part. The build material distribution device (100) of the present specification can form layers of powdered build material that are less than 50 micrometers thick and wherein the powdered build material includes particles having a diameter less than 20 micrometers. Moreover, in some examples, the particles deposited have non-uniform shapes. For example, metal and ceramic particles may be formed by crushing larger objects into small particles. Such particles may have a non-uniform diameter based on the crushing operation. Due to the non-invasive deposition of the build material distribution device (100), the above-mentioned difficulties in using non-uniform and small particles are overcome.

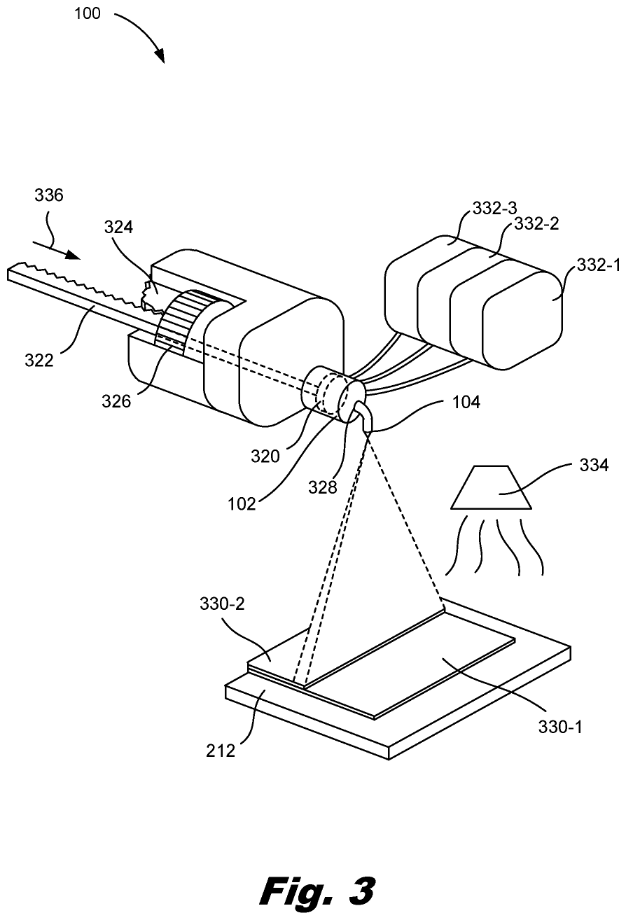

Specifically, the build material distribution device (100) includes a pressurized container (102) to hold a suspension of a powdered build material in a liquid carrier. In some examples, the pressurized container (102) may be a rotating pressurized container (102) as depicted in FIG. 3.

Following deposition, the liquid carrier is extracted such that just the powdered build material remains and is used to form a 3D printed part. A variety of liquids may be used as the liquid carrier. Examples include water and isopropyl alcohol (IPA), although others may be used. The liquid carrier facilitates the ejection and deposition of the powdered build material. By holding the powdered build material in a liquid carrier, a uniform layer of material may be deposited. That is, the liquid carrier will distribute evenly across a substrate on which it is disposed. Then, as the liquid carrier is evaporated away, either due to environmental conditions or aided by an external device, just the powdered build material is left, still in the even layer. The suspension may have any variety of solid-to-liquid ratios. For example, the suspension may be made up of more than 60% of solid powdered build material particles.

In some examples, to prevent agglomeration of solid build material particles disposed in the liquid carrier, dispersants may be added to the suspension. For example, inorganic nanoparticles that may include silica, titania, and other metal oxides may be added. Organic dispersants, either anionic, cationic, or zwitterionic may also be used.

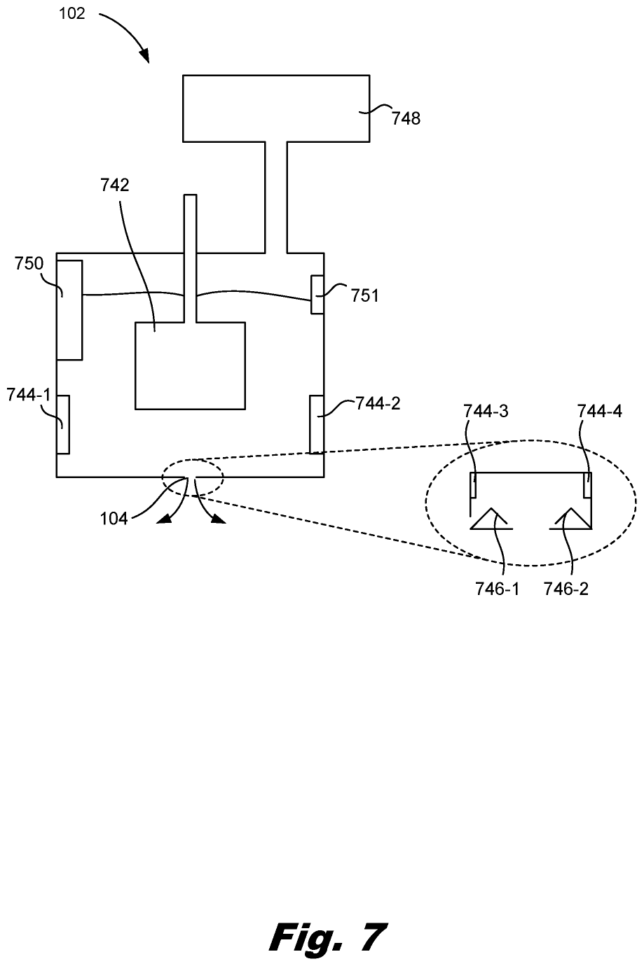

As described above, in some examples the pressurized container (102) rotates to ensure that the powdered build material is evenly distributed in the suspension. That is, were the pressurized container not to rotate, the suspension may become stagnant in the container and the particulate powdered build material may settle. In some examples, this may clog the distribution system, i.e., nozzles, openings, and/or tubes. Still further, the settling of the powdered build material results in non-uniform concentrations of the powdered build material in the suspension. This non-even concentration may result in 1) non-uniform deposition of the powdered build material on a substrate, and 2) a layer with a non-uniform thickness. This may reduce the quality of a printed part. In other words, the rotating pressurized container (102) ensures a uniform mixture of the powdered build material and the liquid carrier such that a uniform distribution of the powdered build material is made. As will be described below in connection with FIG. 7, in some examples when a pressurized container (102) is not used, a disruptor may be introduced into the pressurized container (102) or the nozzle (106) to ensure uniform mixture of the powdered build material and the liquid carrier.

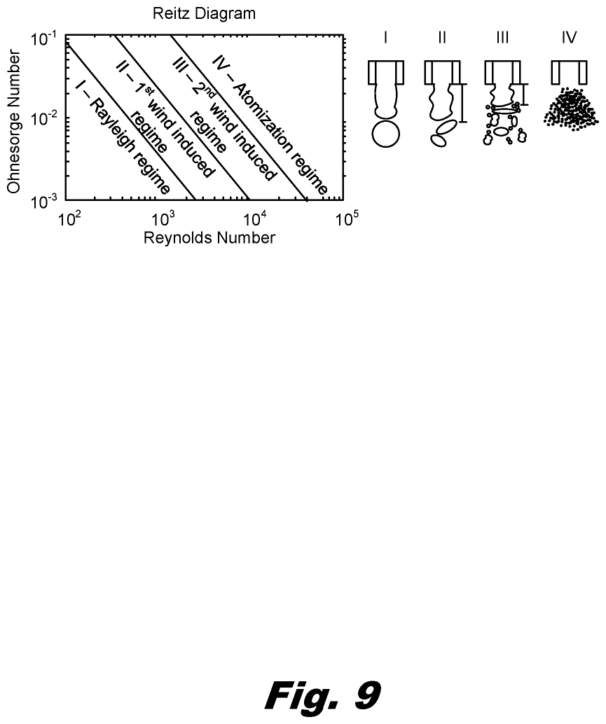

The distribution device (100) also includes a nozzle (104) through which the suspension is ejected. That is, the liquid/solid particle suspension stored in the rotating pressurized container (102) is forced out of a small nozzle (104) by a pressure differential between the inside container and the external environment (surrounding air or other ambient at atmospheric pressure). As depicted in FIG. 9, the behavior of the liquid jet emerging from the nozzle (104) may fall into one of four categories. Laminar flow with the jet breaking into large drops far away from the nozzle (104) (regime 1); formation of jet surface waves introducing turbulence which can break the jet into smaller drops either far away from (regime 2) or close to (regime 3) the nozzle (104), and complete jet atomization into very small droplets occurring within the nozzle (104) (regime 4).

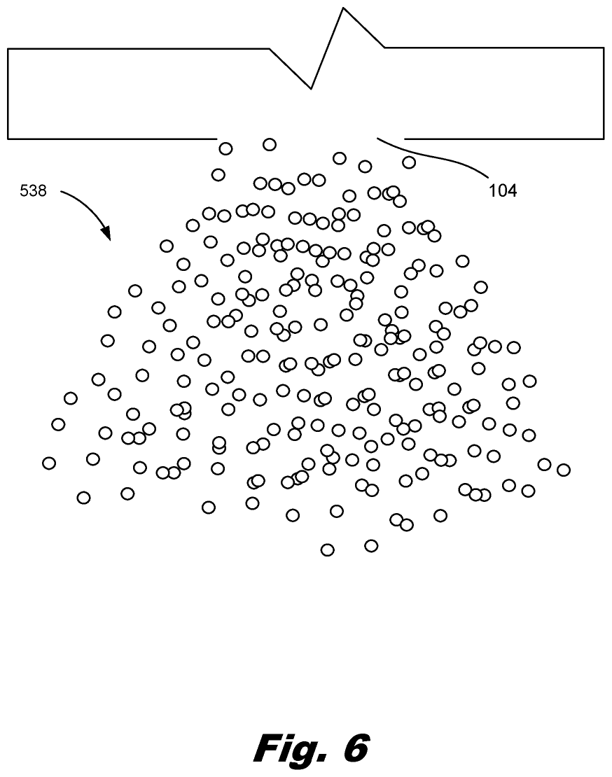

The nozzle (104) may take on a variety of sizes and/or cross-sectional shapes and the exact jetting behavior is determined by a number of jetted material properties, nozzle (104) properties, and other properties of the distribution device (100) in general. Additional information regarding these different properties and their effect on how the suspension is ejected is described in connection with FIG. 6. In general, the distribution device (100) may eject an atomized suspension (regime 4), which may allow for effective, efficient, reliable and uniform layer deposition.

The distribution device (100) also includes a pressurizer (106) that is coupled to the pressurized container (102). The pressurizer (106) generates a pressure within the pressurized container (102) that ejects the suspension through the nozzle (104). The pressurizer (106) may take many forms. For example, the pressurizer (106) may be a piston pump that moves into the pressurized container (102) to increase the pressure which forces the suspension out the nozzle (104). In another example, the pressurizer (106) pumps gas into the pressurized container (102) to generate the pressure which expels the suspension. The pressure generated by the pressurizer (106) may be different based on the application. For example, the pressure may be 10 atmospheres, 5 atmospheres, 2 atmospheres, or 1.5 atmospheres, among others.

Such a distribution device (100), by ejecting the powdered build material as a suspension in a liquid carrier, can deposit a uniform layer that does not need to be further smoothed by a mechanical device, thus avoiding any disturbance of the layer and resulting in a smooth layer of potentially small and uneven particles.

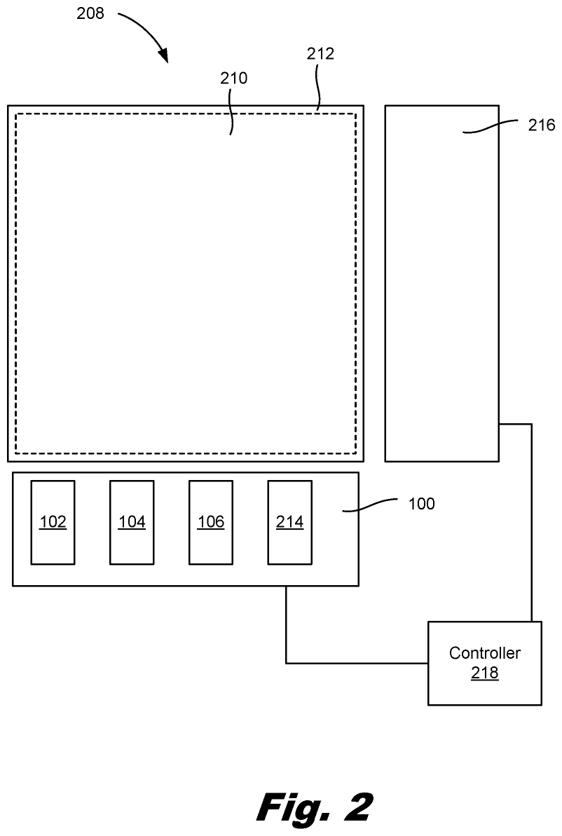

FIG. 2 is a simplified top view of an additive manufacturing system (208) for build material distribution, according to an example of the principles described herein. In general, apparatuses for generating three-dimensional objects may be referred to as additive manufacturing systems (208). The additive manufacturing system (208) described herein may correspond to three-dimensional printing systems, which may also be referred to as three-dimensional printers. In an example of an additive manufacturing process, a layer of build material may be formed in a build area (210). As used in the present specification and in the appended claims, the term “build area” refers to an area of space wherein the 3D object is formed. The build area (210) may refer to a space bounded by a bed (212).

In the additive manufacturing process, any number of functional agents may be deposited on the layer of build material. One such example is a fusing agent that facilitates the hardening of the powder build material. In this specific example, the fusing agent may be selectively distributed on the layer of build material in a pattern of a layer of a three-dimensional object. An energy source may temporarily apply energy to the layer of build material. The energy can be absorbed selectively into patterned areas formed by the fusing agent and blank areas that have no fusing agent, which leads to the components to selectively fuse together. This process is then repeated until a complete physical object has been formed. Accordingly, as used herein, a build layer may refer to a layer of build material formed in a build area (210) upon which the functional agent may be distributed and/or energy may be applied.

Additional layers may be formed and the operations described above may be performed for each layer to thereby generate a three-dimensional object. Sequentially layering and fusing portions of layers of build material on top of previous layers may facilitate generation of the three-dimensional object. The layer-by-layer formation of a three-dimensional object may be referred to as a layer-wise additive manufacturing process.

In another example, a binder is selectively deposited on to particular areas of the build material to adhere select areas of the build material together. This is again done in a layer-wise fashion. Once all layers of the 3D printed object have been formed, the “green” part is passed to a sintering furnace where it is heated and where pressure is applied to burn out the binder and to sinter particles together.

The additive manufacturing system (100) includes a build material distribution device (100) to successively deposit layers of the build material in the build area (210). As described above, the build material distribution device (100) includes various components such as a pressurized container (102), which may be a rotating pressurized container (102), to hold a suspension of a powdered build material in a liquid carrier, at least one nozzle (104) through which the suspension is ejected, and a pressurizer (106) coupled to the pressurized container (102) to eject the suspension through the nozzle (104). In the example depicted in FIG. 1, the pressurized container (102) rotated to ensure even distribution of the powdered build material throughout the liquid carrier. However, other methods of ensuring even distribution are also available. For example, the distribution device (100) may include a disruptor (214) disposed within at least one of the pressurized container (102) and the nozzle (104) to introduce turbulence into the suspension. Such turbulence prevents the particles from settling in the liquid carrier and thus ensures a consistent concentration gradient throughout the suspension. FIG. 7 below provides examples of different disruptors (214) that may be present to introduce the turbulence.

In some examples, the build material distributor (100) may be coupled to a scanning carriage. In operation, the build material distribution device (100) places build material in the build area (210) as the scanning carriage moves over the build area (210) along the scanning axis. While FIG. 2 depicts the build material distribution device (100) as being orthogonal to the agent distributor (216), in some examples the build material distribution device (100) may be in line with the agent distributor (216).

As described above, following deposition of the suspension, the liquid carrier is evaporated. This may be due to environmental conditions, or due to an external heater in the additive manufacturing system (208).

The additive manufacturing system (208) includes an agent distributor (216) to selectively apply an agent such as a fusing agent or a binder to a layer of powdered build material to form a three-dimensional (3D) printed part. In some examples, an agent distributor (216) includes at least one liquid ejection device to distribute a functional agent onto the layers of build material.

A liquid ejection device may include at least one printhead (e.g., a thermal ejection based printhead, a piezoelectric ejection based printhead, etc.). In some examples, the agent distributor (216) is coupled to a scanning carriage, and the scanning carriage moves along a scanning axis over the build area (210). In one example, printheads that are used in inkjet printing devices may be used as an agent distributor (216). In this example, the functional agent may be a printing liquid. In other examples, an agent distributor (216) may include other types of liquid ejection devices that selectively eject small volumes of liquid.

While specific reference is made to agent-based systems. The powder build material distribution device as described herein may be implemented in non-agent based systems such as selective laser sintering and selective laser melting additive manufacturing processes.

The additive manufacturing system (208) also includes a controller (218) to adjust operation of the build material distribution device (100) and the agent distributor (216) to print, in a layer-wise fashion, the 3D printed part. For example, the controller (218) may determine a pattern in which the binder is to be deposited on the layer of build material to form a slice of the 3D printed part. The controller (218) may also alter any number of ejection parameters for the powdered build material. That is, the controller (218) may operate the pressurizer (106) to effectuate a desired pressure within the pressurized container (102) so as to eject the suspension through the nozzle (104). In some examples, the controller (218) may adjust any number of operations based on the environmental conditions. That is, as described above, the ejection characteristics of the suspension are based on any number of environmental conditions. As those conditions change, the controller (218) may alter the pressure within the pressurized chamber (102) to ensure a desired, and consistent ejection of the suspension.

One specific characteristic that may be adjusted by the controller (218) is the speed of ejection. That is, the speed of ejection affects the thickness of a deposited layer. For example, if a jetting speed is too great, the deposition of thin layers may not be mechanically feasible. In some examples, the build material distribution device (100) may operate such that the suspension is ejected between 4 meters per second to 25 meters per second. In some examples, the speed of ejection may be altered by adjusting the internal pressure at the pressurized container (102).

In addition to controlling the speed of ejection, the controller (218) may control the speed at which the scanning carriage moves, which may also affect layer thickness. That is, the controller (218) may determine a speed at which to move the scanning carriage such that a desired layer thickness (i.e., 50 micrometers thick) results. In some examples, moving too fast or moving to slow may not be mechanically feasible and may result in layers that are either too thick or too thin. The speed of movement of the scanning carriage may be based on the rate of removing the liquid from the sprayed layer. It may also account for the fact that a moving nozzle (FIG. 1, 104) deposits the spray twice as it passes over a given point.

Thus, sprayed suspension, as controlled by the controller (218) can provide well controlled formation of a thin particle layer. Moreover, the ejection as described herein can avoid disturbing previously deposited particles and the use of a liquid-solid suspension can enhance particle redistribution to result in a uniformly smooth surface.

FIG. 3 is an isometric view of a build material distribution device (100), according to an example of the principles described herein. As depicted in FIG. 3, the build material distribution device (100) deposits layers (330) of a suspension. The layers (330) may be disposed on a bed (212).

As described above, the 3D printing process involves the sequential deposition of build material. For example, a first layer (330-1) may be deposited. The liquid carrier is evaporated off, and a functional agent such as a fusing agent or binder disposed in a particular pattern to form a slice of a 3D printed part. Next, the build material distribution device (100) operates again to deposit a second layer (330-2). Note that as described above, the whole build material distribution device (100) may move across a surface of the bed (212) to deposit the layers (330).

FIG. 3 also depicts the pressurized container (102) and the nozzle (104) through which the suspension is ejected. As described above, in some examples, the pressurized container (102) rotates so as to maintain an even concentration of the suspension of the powdered build material in the liquid carrier. In this example, the nozzle (104) may not rotate in order to ensure accurate deposition of the suspension. Accordingly, in this example, the build material distribution device (100) includes a slip seal (328) between a rotating pressurized chamber (102) and the nozzle (104). In other words, the slip seal (328) couples and seals, a rotating member, i.e., the pressurized container (102) with a non-rotating member, i.e., the nozzle (104). Note that the nozzle (104) may be coupled in any number of fashions to the rotating pressurized chamber (102) and the slip seal (328) thereby may be positioned at any point along the coupling. For example, the slip seal (328) may be adjacent the pressurized chamber (102) and may couple the pressurized chamber (102) to a stationary feed tube. In another example, the slip seal (328) may be adjacent the nozzle (104) and couple the stationary nozzle (104) to a rotating feed tube. Accordingly, in this example, the feed tube, along with the pressurized container (102) rotates.

The pressurized container (102) may be sized based on a number of criteria. For example, the pressurized container (102) may be sized based on a number of layers (330) of material it holds. For example, the pressurized container (102) may hold enough material to deposit between 1 and 100 layers (330).

The rotation of the pressurized container (102) may be effectuated in any number of ways. For example, the pressurized container (102) may be affixed to a gear (326). Via operation of a motor, the gear (326) which may be rigidly attached to the pressurized container (102), may rotate at a particular angular speed. Accordingly, the pressurized container (102) may also rotate. While one particular example is provided, other mechanisms may be used to rotate the pressurized container (102) including shafts, belts, chains, etc.

As described above, the pressurizer (FIG. 1, 106) is a component of the build material distribution device (100) that imparts an ejecting pressure within the pressurized container (102). The pressurizer (FIG. 1, 106) may take many forms. For example, the pressurizer (FIG. 1, 106) may be a piston pump (320). In this example, the piston pump (320) moves laterally within the pressurized container (102). As depicted in FIG. 3, the piston pump (320) is indicated in dashed lines to indicate its presence internal to the pressurized container (102).

The piston pump (320) may be actuated in any number of fashions. For example, a rack (322) is coupled at one end to the piston pump (320) while a pinion (324) gear operates to drive the rack (322) back and forth laterally. When driven in one direction, as indicated by the arrow (336), the piston pump (320) increases pressure within the pressurized container (102) such that the suspension is ejected out. Specifically, pressure inside the pressurized container (102) is controlled by the piston pump (320) which moves to maintain constant pressure within the pressurized container (102) as the pressurized container (102) is depleted via printing.

The piston pump (320) may also retract in an opposite direction which reduces the pressure in the pressurized container (102). This creates a backpressure that prevents suspension leakage when printing has ceased, for example between jobs or while the fusing agent is being deposited. The ability of the piston pump (320) to retract in this fashion prevents dripping and controls vessel expansion pressure thereby preventing unwanted material discharge, and does so without a check valve. The reversal of the piston pump (320) also provides a predetermined starting pressure for the next layer cycle without monitoring devices.

Upon return of the piston pump (320), additional material may be loaded into the pressurized container (102). Accordingly, no motion is wasted as suspension is ejected as the piston pump (320) moves in one direction and fluid is supplied to the pressurized container (102) as the piston pump (320) moves in another direction.

As described above, the controller (FIG. 2, 218) controls the pressure within the pressurized container (102) and may do so by controlling the rack (322) and pinion (324). Accordingly, using the controller (FIG. 2, 218), the build material distribution device (100) is able to hold a precise amount of mixture to produce the desired number of layers to be applied, facilitates consistency, and reduces waste.

The piston pump (320) and the associated driving mechanism can deliver accurate quantities of a suspension and may change the operating pressures relatively quickly to reduce waste and provide a consistent spray. For example, the build material distribution device (100) in the additive manufacturing system (FIG. 2, 208) may include any number of supply reservoirs (332-1, 332-2, 332-3) coupled to the rotating pressurized chamber (102). The reservoirs (332) supply any variety of material including different formulations of powdered build material. In an example, one of the reservoirs (332) includes a flushing liquid that may be used pre- or post-printing to clean the pressurized container (102), feed tube, and/or nozzle (104).

In some examples, the supply reservoirs (332) may be stationary and thus may each include a slip seal to couple the non-rotating reservoirs (332) to the rotating pressurized container (102). In some examples, each supply reservoir (332) also includes a valve to be selectively opened and closed by the controller (FIG. 2, 218) to selectively introduce the contents therein into the pressurized container (102). That is, a respective valve may be opened and the fluid contained in the reservoir (332) may be introduced into the pressurized container (102) during retraction of the piston pump (320). The introduction may be based on the pressure differential between the supply reservoirs (332) and the backpressure created in the pressurized container (102) via the retraction of the piston pump (320). During this reloading phase, the nozzle (104) may be closed to prevent fluid leakage and to maintain a pressure whereby fluid is drawn to the pressurized container (102) from the reservoirs (332).

As described above, prior to deposition of the functional agent (e.g., the fusing agent or binder), the liquid carrier of the suspension may be removed. That is, the liquid component of the sprayed layers (330) should be quickly removed in a 3D printing application. In some examples, this can be achieved by holding the powder bed (212) at an elevated temperatures. As a specific numeric example, a 50-micrometer thick layer (330) of a suspension that includes 50% load of stainless-steel powder dispersed in water, deposited on a bed (212) held at 100 degrees Celsius, may completely lose the liquid components in less than 0.2 seconds.

Accordingly, in some examples, the additive manufacturing system (FIG. 2, 208) includes a heater (334) to evaporate the liquid carrier from a surface on which the suspension is deposited. Doing so leaves a layer of powdered build material without the liquid carrier. A heater (334) may be any component that applies thermal energy. Examples of heaters (334) include infrared lamps, visible halogen lamps, resistive heaters, light emitting diodes LEDs, and lasers. That is, the heater (334) heats the bed (212) to a predetermined temperature so as to increase the evaporation rate of the liquid carrier of the suspension. The heater (334) thereby reduces the amount of time between operation of the build material distribution device (100) and the agent distributor (FIG. 2, 216).

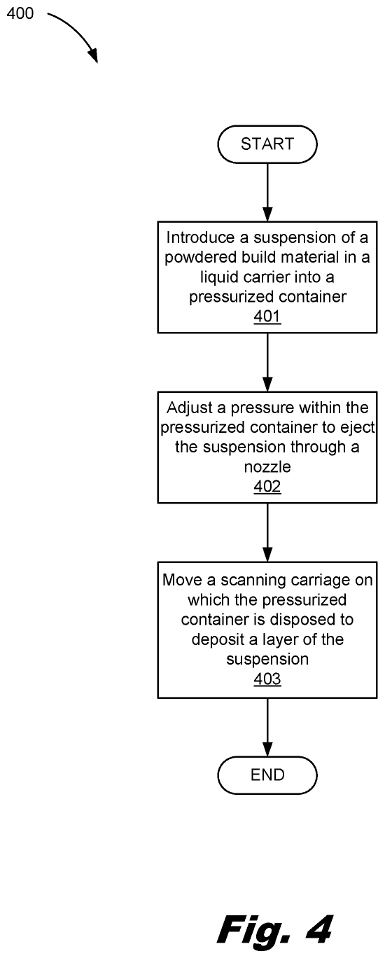

FIG. 4 is a flow chart of a method (400) for build material distribution, according to an example of the principles described herein. According to the method (400), a suspension of powdered build material in a liquid carrier is introduced (block 401) into a pressurized container (FIG. 1, 102), which pressurized container (FIG. 1, 102) may be rotating. As described above, the suspension may be made up of multiple powdered particles disposed in a variety of liquid carriers. Moreover, the suspension may be at any ratio. For example, the suspension may include more than 50% by volume or weight of the powdered build material. In another example, the volume load of the powdered build material in the suspension may be 20%.

The suspension may initially reside in a supply reservoir (FIG. 3, 332) and via the opening of a valve by a controller (FIG. 2, 218), may be drawn into the rotating pressurized container (FIG. 1, 102). For example a negative pressure within the pressurized container (FIG. 1, 102) may be generated by pulling a piston pump (FIG. 3, 320) further out in the pressurized container (FIG. 1, 102), thus increasing the volume of the pressurized container (FIG. 1, 102). The pressure is then adjusted (block 402) to eject the suspension from the nozzle (FIG. 1, 104). That is, the pressurizer (FIG. 1, 106) may increase the pressure within the pressurized container (FIG. 1, 102) to a point that the pressure differential is sufficiently great to force the suspension out the nozzle (FIG. 1, 104). This may be done in any number of fashions including by increasingly inserting a piston pump (FIG. 3, 320) into the pressurized container (FIG. 1, 102).

A scanning carriage on which the build material distribution device (FIG. 1, 100) is disposed is then moved (block 403). More specifically, the scanning carriage is intended to move across the surface of a bed (FIG. 2, 212). As it does so, the suspension is ejected out, in an atomized form for example, to deposit a uniform layer (FIG. 3, 330) of the suspension on the substrate. Thus, the present method (400) describes a way to deposit a uniform layer of a material that is to be used in an additive manufacturing process.

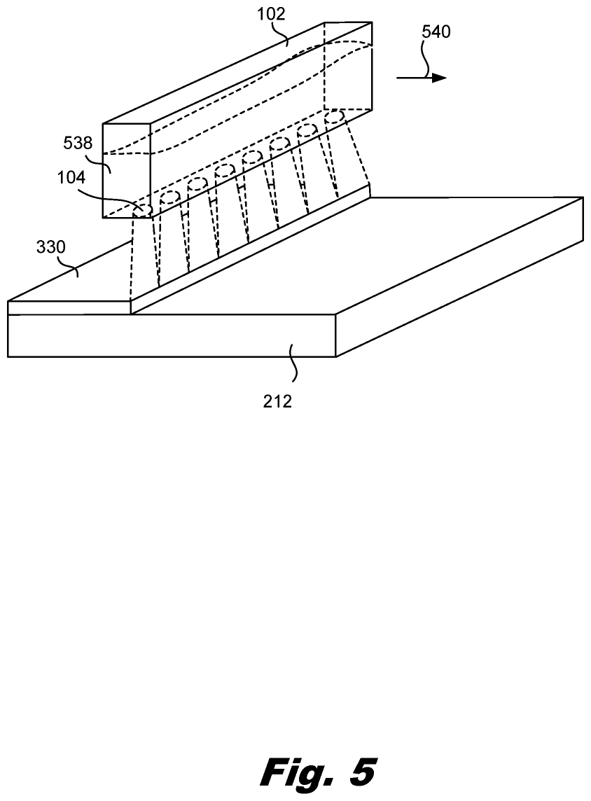

FIG. 5 is a diagram for powdered material distribution, according to an example of the principles described herein. FIG. 5 depicts the bed (212) on which a layer (330) of the suspension (538) is deposited. In the example depicted in FIG. 5, rather than ejecting from a single nozzle (104), the build material distribution device (FIG. 1, 100) includes an array of nozzles (104). That is, multiple nozzles (104) may be fluidly coupled to the pressurized container (102). For simplicity in FIG. 5, just one nozzle (104) is indicated with a reference number. In this example, and as described above, the pressurized container (102) may move across the surface of the bed (212) as indicated by the arrow (540) to deposit the layer (330) uniformly across the bed (212).

FIG. 6 is a diagram of the ejection of powdered material, according to an example of the principles described herein. As described above, various characteristics affect the ejection of the suspension (538) from the nozzle (104). These characteristics can be tuned to result in desired ejection characteristics. In general, a continuous spraying action is achieved by forcing the suspension (538) through a narrow nozzle (104) having a circular opening. A circular opening may result in a conical spray pattern. However, in other examples, other shapes of nozzles (104) may be implemented including a ring, a square, a triangle, etc.

Different nozzle (104) geometries may change the fluid turbulence within the pressurized container (FIG. 1, 102). The size of the nozzle (104) also effects the area of the substrate covered by the spray. In some examples, the diameter of the nozzle (104) may be greater than three times the particle diameter. In some examples, the nozzle (104) may be 50 micrometers, 100 micrometers, or 150 micrometers in diameter.

The jet emerging from the nozzle (104) disintegrates into an array of droplets based on stabilizing forces such as surface tension and deforming forces such as flow turbulences.

In general, the flow out of the nozzle (104) may be grouped into four categories depending on the suspension properties and the jetting parameters. The categories are depicted in FIG. 9 below.

The first group, or first regime corresponds to low-speed laminar flow through the nozzle (104) with the jetted suspension (538) breaking into large droplets far away from the nozzle (104). In the second and third regimes, as the jet velocity increases, turbulence starts occurring and oscillations of the jet's surface starts breaking the jet into smaller droplets closer to the nozzle (104). In the fourth regime, which is atomization as depicted in FIG. 6, the jet disintegrates within the nozzle (104) and the droplet's size decreases even further. Atomizing the suspension (538) prior to, or during ejection, may allow for very thin layers (FIG. 3, 330) of material to form on the surface. In some examples, each spray droplet may contain up to several powder particles. For example, the nozzle (104) characteristics, pressure within the pressurized container (FIG. 1, 102), temperature within the pressurized container (FIG. 1, 102) and other characteristics may be tuned such that 10% of a sprayed volume contains liquid-only droplets.

The atomization of the suspension (538) may also ensure that an underlying layer (FIG. 3, 330) is not impacted. That is, the suspension (538) may be tuned such that the impingement force of a droplet on a layer (FIG. 3, 330) does not disturb the underlying layer.

A Reitz diagram may be used to determine whether formed droplets are small enough to provide uniform coverage of the spread material and whether the droplets are formed close enough to the nozzle (104) to provide adequate distance from the substrate on which they are sprayed. In general, the characteristics of the build material distribution device (FIG. 1, 100) may be adjusted such that the suspension (538) is atomized, i.e., is in the fourth regime, or near the border between the third regime and the fourth regime. That is, it may be desirable in terms of layer uniformity, when the sprayed materials fall in regime 4 or along the border between regime 3 and 4.

The controller (FIG. 2, 218) may adjust the operation of the build material distribution device (100) based on the properties of the suspension (538) and the system as a whole. That is, how to achieve the atomization state or near atomization state varies depending on the material properties. For example, while the specification describes ejection properties based on a particular build materials and liquid carriers, similar results may be expected for other solid particles, other solvents, and their mixtures because of the similar values of their material parameters. As a specific example, heating of the sprayed mixture within the pressurized container (FIG. 1, 102) may shift spray conditions towards the fourth regime, i.e., atomization, allowing for the formation of finer droplets or jet disintegration closer to the nozzle (104). Raising of the mixture temperature by few tens of degrees can be accomplished with resistive heaters built into the pressurized container (FIG. 1, 102).

Atomizing a suspension (538) provides for even, and thinly deposited layers (FIG. 3, 330). That is, the droplet's liquid flows along the surface towards locations of minimal energy (i.e., lowest points) thus filling any gaps in the layer and ensuring a uniform, smooth, and/or level surface.

FIG. 7 is a diagram of a pressurized container (102) in a build material distribution device (FIG. 1, 100), according to an example of the principles described herein. As described above, in some examples, a disruptor (FIG. 2, 214) is included to increase the turbulence in the pressurized container (102) such that the solid particles are evenly distributed in the liquid carrier. Without such a disruptor (FIG. 2, 214), the particles may settle leading to clogging and/or uneven distribution of the powdered build material within the liquid carrier which may result in uneven, or non-uniform build material layers (FIG. 3, 330). FIG. 7 depicts various examples of turbulence-inducing disruptors (FIG. 2, 214). While FIG. 7 depicts various examples, the build material distribution device (FIG. 1, 100) may include just one of the below described components or another disruptor (FIG. 2, 214).

As one example, the disruptor (FIG. 2, 214) may be a mixing paddle (742). In this example, a controller (FIG. 2, 218) may control the rotation of the mixing paddle (742) which stirs the suspension to ensure an even and uniform distribution of solid particles within the liquid carrier. That is, the suspension may be unstable, especially when particles are greater than a few hundred nanometers and the particles tend to segregate due to gravity. A stirring of the mixture via the mixing paddle (742) may ensure uniform dispersion of the particles in the liquid carrier. Another example, may include blowing gas bubbles through the mixture to disperse segregated particles.

As yet another example, ultrasound generators (744-1, 744-2) may be disposed within the pressurized container (102). The ultrasound generators (744) generate ultrasonic waves that mix the contents of the pressurized container (102).

As described above, the disruptor (FIG. 2, 214) may be disposed in the pressurized container (102) itself or in the nozzle (104). FIG. 7 depicts an example with ultrasound generators (744-3, 744-4) disposed in the nozzle (104). Other examples of components that may be used to disrupt the fluid mechanics, and thereby ensure uniform dispersion of the powdered build material in the liquid carrier, include protrusions (746-1, 746-2) in the pressurized container (102) and/or the nozzle (104). The protrusions (746) may affect the flow path of the suspension as it moves through the pressurized container (102) or the nozzle (104) such that turbulence dissipates the powdered build material throughout the liquid carrier.

In some examples, the operation of the disruptor (FIG. 2, 214) in its various form may be adjusted by including in the pressurized container (102) a sensor (751) capable of detecting settling/non-uniform distribution of solids in the mixture. The sensor (7510) may be of a variety of types including an electrical conductivity sensor, an optical opacity sensor, etc.

Note that while FIG. 7 depicts multiple various examples of disruptors (FIG. 2, 214), the build material distribution device (100) may include any number, including just one, of any type of the aforementioned disruptors (FIG. 2, 214).

FIG. 7 also depicts another example of a pressurizer (FIG. 1, 106). In this example, the pressurizer (FIG. 1, 106) may include a pressurized gas chamber (748) fluidically connected to the pressurized chamber (102). The introduction of gas into the pressurized container (102) increases the pressure thus forcing the suspension out the nozzle (104). In either case, i.e., the pressurized gas chamber (748) or the piston pump (FIG. 3, 320), the build material distribution device (FIG. 1, 100) may include a pressure sensor (750) to detect, and maintain a constant pressure within the pressurized container (102).

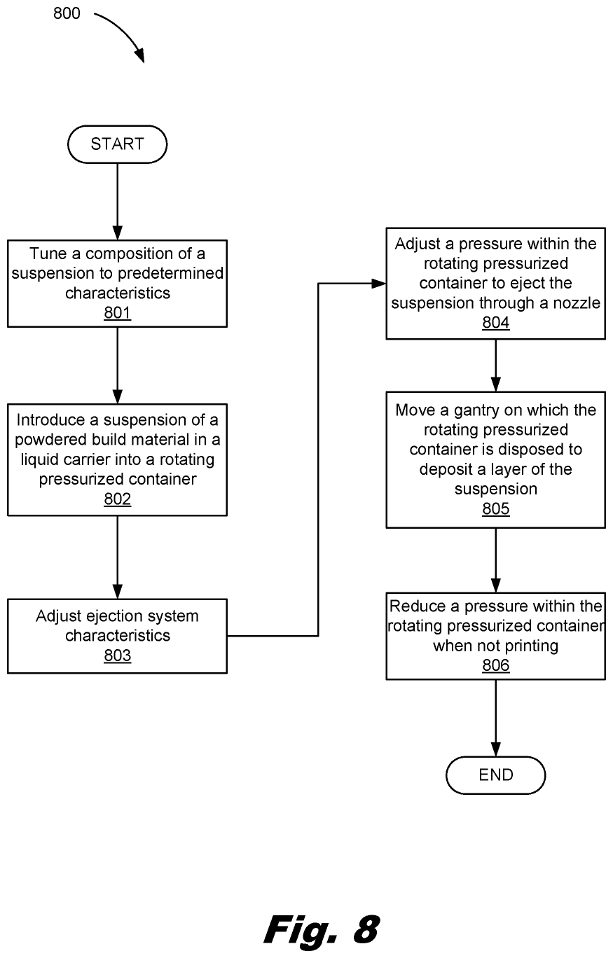

FIG. 8 is a flow chart of a method (800) for build material distribution, according to another example of the principles described herein. According to the method (800), a composition of the suspension is tuned (block 801) such that predetermined deposition characteristics are generated. That is, as described above, in order to achieve atomization of the suspension, various characteristics of the suspension as well as the build material distribution device (FIG. 1, 100) may be adjusted. Examples of such parameters that may be adjusted include a shape of the particles, a density of the mixture, a dynamic viscosity of the mixture, a surface tension of the mixture and a temperature of the mixture.

Accordingly, different ingredients in different quantities may be added to the suspension to achieve desired characteristics such that desired ejection characteristics result. The suspension is then introduced (block 802) into a rotating pressurized container (FIG. 1, 102). This may be done as described above in connection with FIG. 4.

Build material distribution device (FIG. 1, 100) characteristics are also adjusted (block 803). These adjustments may be made to ensure atomization of the suspension through the nozzle (FIG. 1, 104). That is, as described above, tuning (block 801) the composition of the suspension is one way of ensuring atomization, but adjusting the operating characteristics of the build material distribution device (FIG. 1, 100) is another example. Such adjustments (block 803) include adjusting a pressure within the rotating pressurized container (FIG. 1, 102), adjusting a temperature within the pressurized container (FIG. 1, 102), adjusting an ejected jet velocity, adjusting a nozzle diameter, adjusting a pressure differential, adjusting a temperature of the heater (FIG. 3, 334) of the additive manufacturing system (FIG. 2, 208), and adjusting an external temperature. Doing so ensures that proper ejection characteristics are present such that the suspension is properly ejected in an atomized, or near atomized form. A scanning carriage on which the rotating pressurized container is disposed is then moved (block 805) as described above in connection with FIG. 4.

Following printing, a pressure within the rotating pressurized container (FIG. 1, 102) is reduced (block 805). Such an operation has multiple effects. First, it prevents leakage of the suspension of the rotating pressurized container (FIG. 1, 102) by generating a backpressure that draws the suspension away from the nozzle (FIG. 1, 104). The reduction of pressure, for example by retracting the piston pump (FIG. 3, 320) also draws fluid into the rotating pressurized container (FIG. 1, 102) from at least one supply reservoir (FIG. 3, 332). Thus, the retraction of the piston pump (FIG. 3, 320), which may otherwise be a wasted motion, is effectively used to prevent leakage and refill the pressurized container (FIG. 1, 102) for another printing pass.

FIGS. 9-13B relate to experimental/test calculations relating to the build material distribution device (FIG. 1, 100) described above. Specifically, FIGS. 9-12D relate to calculations for a single nozzle spray assembly used to deposit thin layer of a liquid/solid metal particle mixture.

Continuous spraying action may be achieved by forcing liquid through a nozzle having a circular opening in a pressurized vessel. A continuous jet of liquid emerging from the nozzle disintegrates into an array of droplets under an array of stabilizing (surface tension) and deforming (flow turbulence) forces acting upon the jet.

Spray formation can be described by the Weber number, the Reynolds number, and the Ohnesorge number. The Weber number, Wₑ, elucidates mixture stabilizing forces and is defined as follows.

$${W}_{e} = \frac{{v}^{2} L ρ}{σ} ,$$

where v=ejected jet velocity, L=diameter of nozzle, ρ=density of sprayed mixture, and σ=surface tension of sprayed mixture. The Reynolds number, Rₑ, elucidates mixture destabilizing forces and is defined as follows.

$${R}_{e} = \frac{vL ρ}{μ} ,$$

where μ=dynamic viscosity. The Ohnesorge number Oₕ relates the Weber number, Wₑ, and the Reynolds number, Rₑ, as follows.

$${O}_{h} = \frac{\sqrt{{W}_{h}}}{{R}_{e}} .$$

The jet velocity is described by Bernoulli's formula

$$v = \sqrt{\frac{2 Δ p}{ρ}} ,$$

where Ap=pressure differential between the liquid inside the spray vessel and the surrounding environment into which the liquid mixture is sprayed (surrounding environment=atmospheric pressure).

Behavior of jetted liquid may fall into one of four categories depending on the liquid properties and jetting parameters. These categories can be illustrated on the Oₕ=f(Rₑ) diagram depicted in FIG. 9. In FIG. 9, the first (Rayleigh) regime corresponds to low-speed, laminar flow through the nozzle with jetted fluid breaking into large droplets far away from nozzle. In the second and third regime, as the jet velocity increases turbulence starts occurring and oscillations of the jet's surface starts breaking the jet into smaller droplets closer to the nozzle. In the fourth regime (atomization), the jet disintegrates within the nozzle and droplet's size decreases even further.

For the calculations, the Reitz diagram depicted in FIG. 9 was used for quick evaluation whether: (a) formed droplets are small enough to provide uniform coverage of the sprayed material, and (b) droplets are formed close enough to the nozzle to provide adequate distance from the substrate on which they are sprayed. In general, sprayed liquid/solid particles mixture should fall into regime IV (complete atomization) or fall near the border between regime III and IV.

Calculations were also performed relating to jetting velocity. That is, experiments were done to determine whether a speed at which a spraying assembly moves allows achieving desired thickness of deposited layer. For example, a high jetting velocity speed of the spraying assembly may be too high to be mechanically feasible.

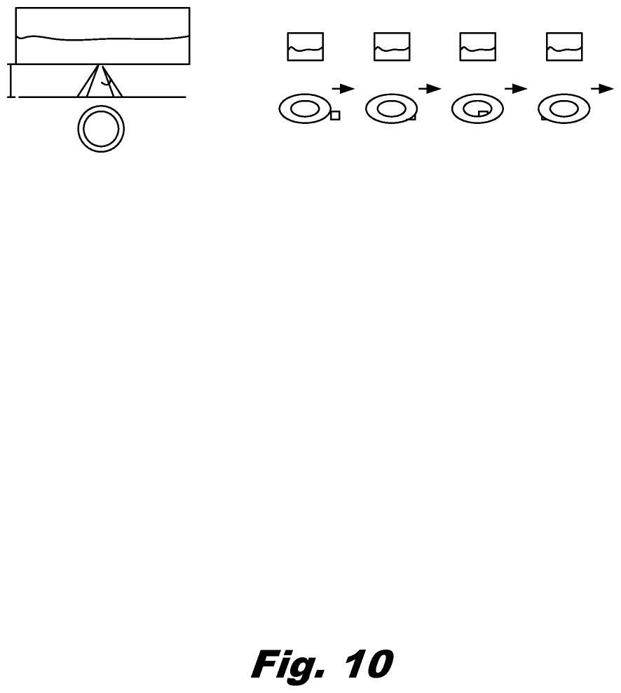

Spray assembly characteristics for the test design details are listed below. Specifically, a single nozzle was assumed and calculations were done for nozzle diameters of 50 um, 100 um, and 150 um. As noted above, a spray pattern depends on the nozzle's geometry. Here, the simplest spray nozzle (circular opening in the pressurized spraying apparatus) is assumed as depicted in FIG. 10. This arrangement generates conical spray pattern shown in FIG. 10 (ring-like region covered with sprayed particles). For the calculations, a 5 mm distance was set between the nozzle and the substrate, which is a reasonable value based on the spray apparatus characteristics.

For the calculations, unidirectional movement of the spraying assembly at a constant velocity was assumed. The speed at which the spraying assembly producing a spray pattern shown in FIG. 10 should move to produce 50 um thick uniform layer was calculated to evaluate mechanical feasibility of the movement (too fast/too slow to be mechanically feasible). These calculations account for the effect of removing (evaporating out) liquid from the sprayed layer. It also accounts for the fact that moving nozzles deposit the spray twice as it passes over a given point as depicted in FIG. 10. Bernoulli's formula assumes frictionless transport through the nozzle. However, in reality, a jet moving through the nozzle may encounter resistance that can reduce jet value by 20%-30%. Therefore, the calculated velocity values should be considered as an upper bound.

For the calculations, a liquid mixture made up of solid (SS—stainless steel particles with sizes below 20 um—consistent with MIM powder) and liquid solvent was used. Particle size enters into consideration when defining nozzle diameter. The calculations assume that nozzle diameter is at least three times greater than the particle diameter. When the particle diameter approaches the nozzle diameter spraying ejection may be in the atomization regime. The calculations considered two liquid solvents, water and isopropyl alcohol (IPA).

Calculations of various pressures (p) of the liquid-solid mixture inside spray assembly—10 atm, 5 atm, 2 atm, 1.5 atm were made with an external pressure of 1 atm. In the calculations, a dynamic viscosity of suspension was calculated using the Einstein's formula μ=μₗ (1+2.5φ), where μₗ is the dynamic viscosity of liquid phase of the mixture and φ is the volume concentration of solid particles in the mixture. In the calculations that follow, a surface tension of the mixture equals a surface tension of its liquid component. Also, in the calculations a majority of material parameters (ρ and σ) may be practically constant within the considered temperature range (20° C. to 80° C.). μ exhibits exponential temperature dependence. According to Reynolds model μ(T)=μ₀ exp(−bT).

The present calculation employed reported value of μ(T) and calculations were done for T=20° C. and T=80° C. The calculations considered two mixture compositions, 50% volume load of metallic particles and 20% volume load of metallic particles, and their densities (φ were calculated by appropriately scaling proportion of liquid-to-solid.

The following density (φ values (kg/m³), surface tension (σ) values (N/m), and dynamic viscosity (μ) values (Pa*s) were used in the calculations:

| ρ | ρ | ρ | ρ (H₂O - | ρ (H₂O - | ρ (IPA - | ρ (IPA - |
|---|---|---|---|---|---|---|
| (SS) | (H₂O) | (IPA) | 50% load) | 20% load) | 50% load) | 20% load) |
| 7,700 | 1,000 | 800 | 4,850 | 2,340 | 4,250 | 2,180 |

| σ | σ | σ | σ |
|---|---|---|---|
| (H₂O - 20° C.) | (IPA - 20° C.) | (H₂O - 80° C) | (IPA - 80° C.) |
| 72 * 10⁻³ | 23 * 10⁻³ | 62 * 10⁻³ | 21 * 10⁻³ |

| μ | μ | μ | μ |
|---|---|---|---|
| (H₂O/20° C.) | (IPA/20° C.) | (H₂O/80° C) | (IPA/80° C.) |
| 1.1 * 10⁻³ | 2.2 * 10⁻³ | 3.6 * 10⁻⁴ | 8.2 * 10⁻⁴ |

| μ (H₂O - 50% | μ (H₂O - 20% | μ (IPA - 50% | μ (IPA - 20% |
|---|---|---|---|
| load/20° C.) | load/20° C.) | load/20° C.) | load/20° C.) |
| 2.48 * 10⁻³ | 1.65 * 10⁻³ | 4.95 * 10⁻³ | 3.3 * 10⁻³ |

| μ (H₂O - 50% | μ (H₂O - 20% | μ (IPA - 50% | μ (IPA - 20% |
|---|---|---|---|
| load/80° C.) | load/80° C.) | load/80° C.) | load/80° C.) |
| 7.1 * 10⁻⁴ | 4.4 * 10⁻⁴ | 2.07 * 10⁻³ | 1.23 * 10⁻³ |

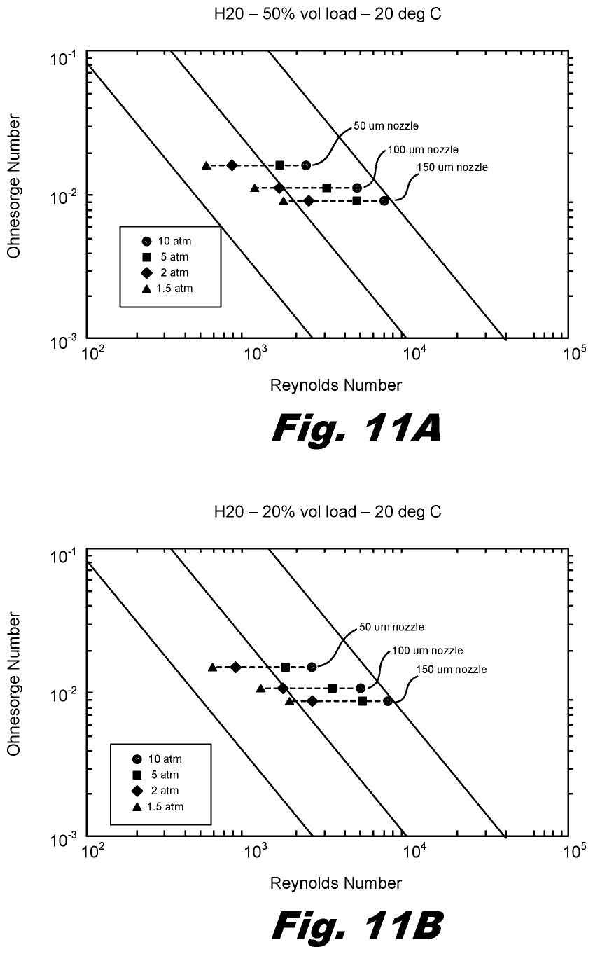

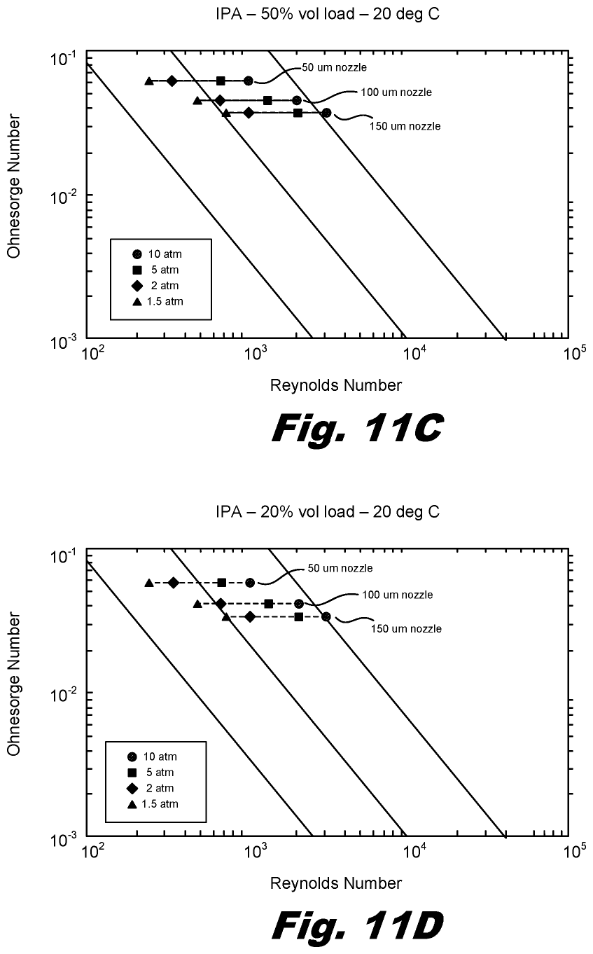

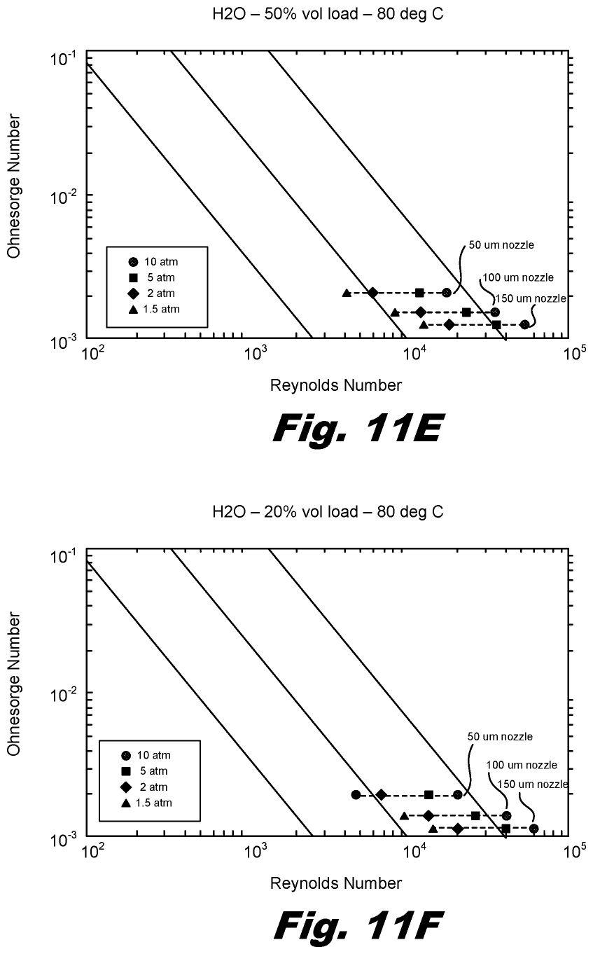

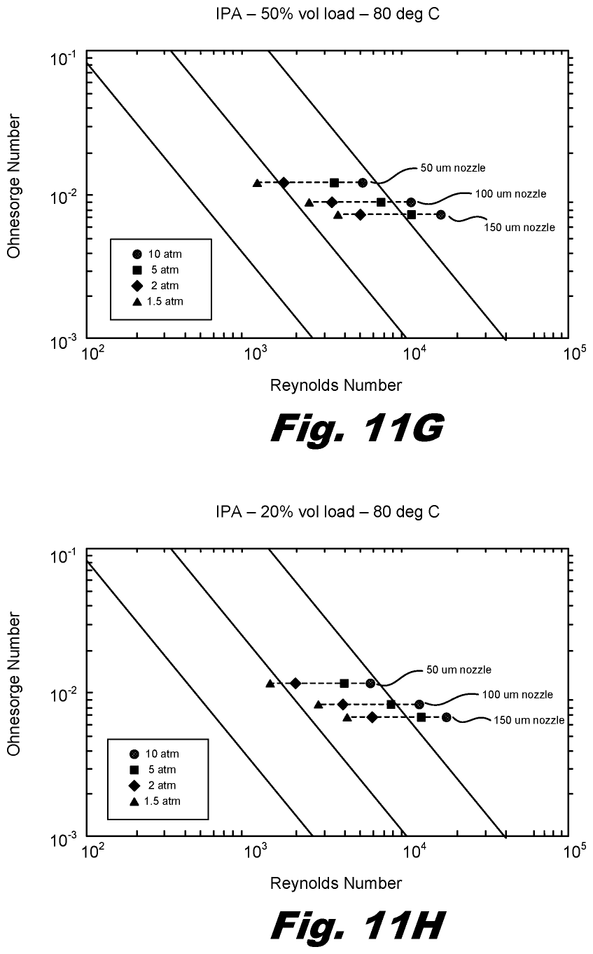

FIGS. 11A-11H depict the various Reitz diagrams for varying pressure, solid load, temperature, liquid, and nozzle diameter. In the diagrams, each set of three points marked with same fill pattern represents different nozzle diameter as indicated.

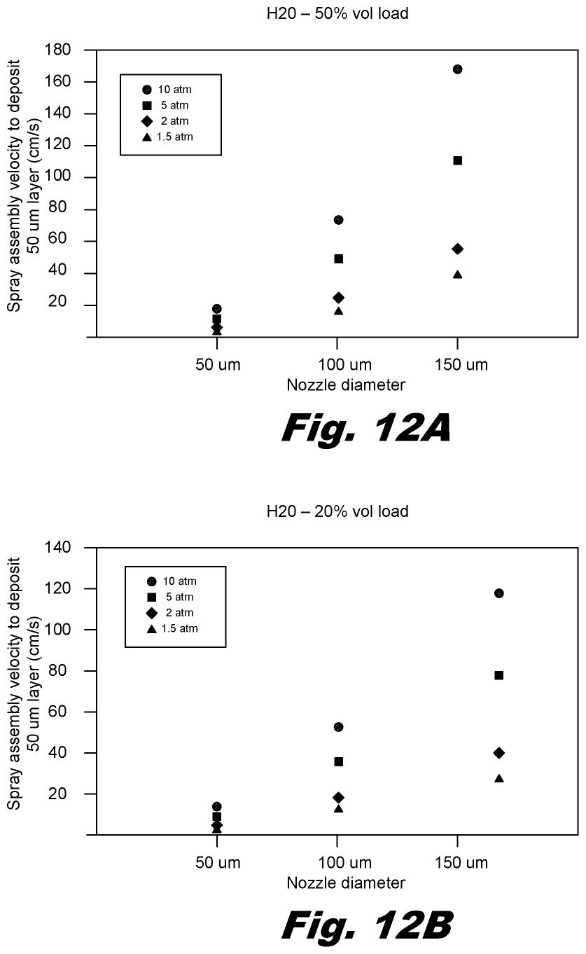

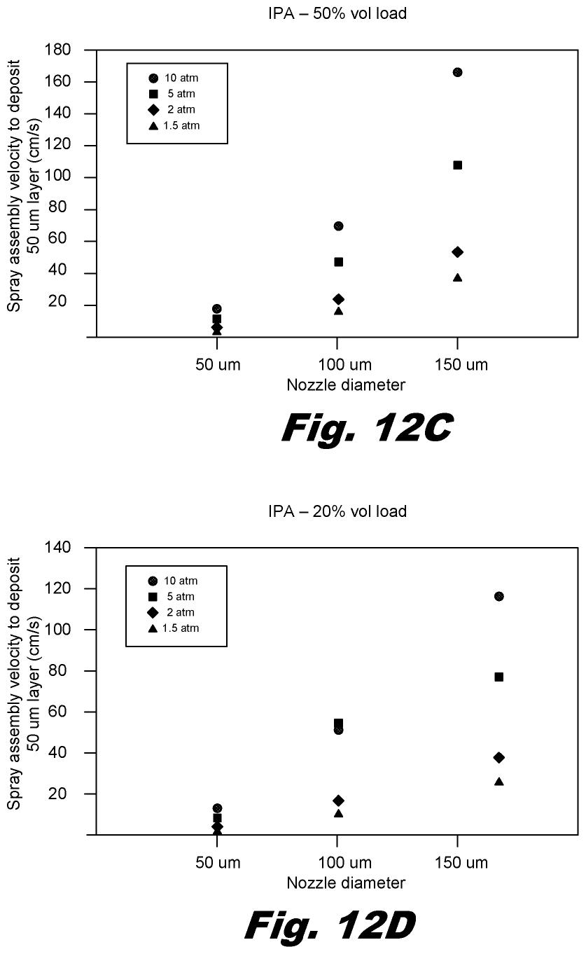

FIGS. 12A-12D depict the velocity of the spray assembly to deposit 50 um thick layer (single pass) for different pressures, solid loads, liquids, and nozzle diameters.

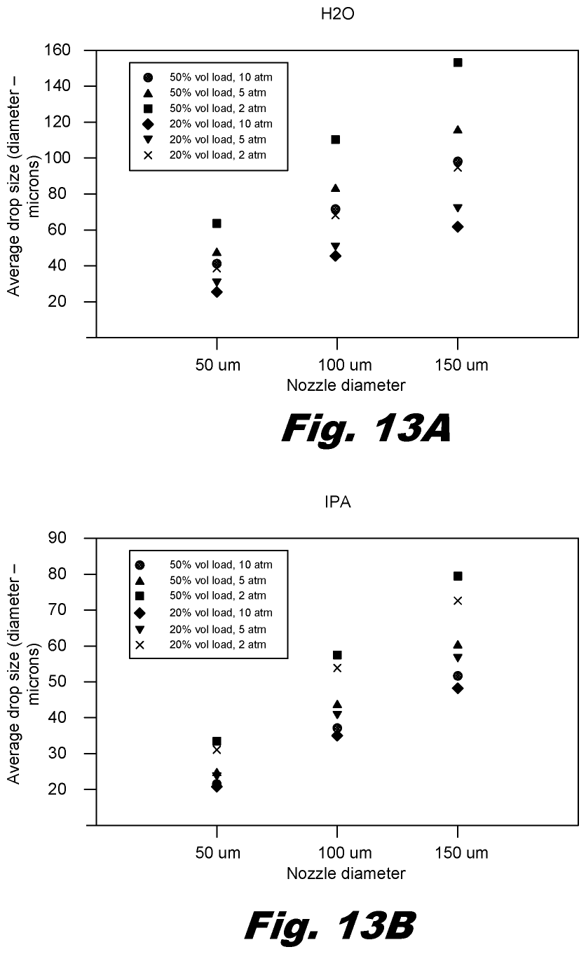

FIGS. 13A and 13B relate to the calculations for a single nozzle spray assembly used to deposit a thin layer of the liquid/solid metal particles mixture. That is, FIGS. 13A and 13B relate to the calculation of events including the flight of spray droplets towards the base surface, their impingement onto the surface, disintegration of the spray droplets, and loss of liquid components following by formation of a solid particles layer. There is no analytical model capable of consistent description of all these phenomena, and therefore they are analyzed using variety of analytical tools.

The calculations were done for droplets made up of previously deposited solid particles. It was assumed that a spray is located between region III and IV on the Reitz diagram and droplets velocity fall within the range of 4 m/s to 25 m/s. For the calculations it was assumed that spray droplet size follows an even volume distribution and, for simplicity, just the mean size of droplets was analyzed. Following semi-empirical model of Reitz Sauter, a mean diameter of spray droplets (assumed to represent “true” mean diameter—spherical particles assumption) can be expressed as: d_{drop}=1.5 (ρₗ/ρₐ)^{0.1} (1/Wₑ)^{0.2}L when Wₑ<1000 and d_{drop}=0.5 (ρₗ/ρₐ)^{0.05} (1/Wₑ)^{0.3}L when Wₑ>1000, where μl and ρa are respectively sprayed liquid and ambient densities, Wₑ is the Weber number and L equals diameter of the nozzle.

FIGS. 13A and 13B shows the calculated mean drop sizes for spraying conditions described above. The calculated droplet's diameter suggest that spray droplets may contain up to several powder particles having size consistent with the MIM powder. From the assumption of even droplet volume distribution and assuming average solid particle size of 15 um, about 10% of sprayed volume may contain liquid-only (no solid particles inside the droplet).

Further complication stems from the fact that liquid within droplet particles evaporate while travelling between the nozzle and base surface causing volume loss or even complete evaporation of the droplet before it reaches the surface. It may happen that some particles may reach the base surface “dry”. i.e. surrounding droplet has evaporated before reaching the surface. A time evaporate liquid droplet may be as high as few milliseconds assuming ambient temperature close to room temperature, and therefore just a few droplets may reach the surface without surrounding liquid solvent. This phenomenon is not included into this calculation.

This phenomenon of droplet impact upon the base surface is described qualitatively. It is assumed that droplet impacts upon “dry” surface, meaning that the effect of surface liquid originating from previously delivered droplets is negligible. A droplet may impact the surface with kinetic energy of about 5×10⁻¹² J (calculated for three particles, with 15 um diameter each, tightly packed into a liquid sphere with radius of 48 um travelling at 10 m/sec), which is comparable with surface energy of the sphere (4×10⁻¹² J—case of H₂O spray solvent). Most of this energy may be absorbed by droplet's surface tension causing that impact to be described as highly plastic droplet deformation. In other words, an impacting droplet does not scatter surface particles but rather deforms, causing increase of its temperature and passing some of its heat (and perhaps some residual kinetic energy) to the surface.

The next operation depends on a droplet's liquid ability to wet the surface. Since identical particles are present on the surface and within the droplet (implying “good” wetting), the calculations assume a liquid droplet flows along the surface towards minimal energy locations (lowest points) and gradually penetrates the base layer through openings between the base layer particles. Liquid movement along the surface can redistribute solid particles delivered by the droplet and may advantageously provide more uniform (smooth) surface coverage with newly delivered particles.

Finally, spray liquid may evaporate due to elevated temperature of the base powder particles. Detailed calculation of this phenomenon relies on an understanding of liquid distribution on the surface and below the surface of base layer. For lack of this information just two extreme conditions are considered: (1) liquid delivered by falling spray droplet remains on the surface in form of hard to evaporate spherical drop (poor surface wetting), and (2) 50% of delivered liquid remains on the flat base surface (the other 50% is neglected) spread in form of flat film with 20:1 aspect ratio (goof wetting and penetration in to underlying layer) and can easily evaporate due to its large surface. Base surface particles are kept at 95° C. and H₂O is used in the spray. Case (1) can be estimated, while case (2) can be easily calculated using tabulated water evaporation rate, volume, and water layer thickness obtained for the assumed spherical droplet.

| Case/temperature = 95° C. | Time to evaporate |
|---|---|
| (1) spherical droplet on the surface - poor wetting | 0.8 sec |
| (2) flat liquid layer - good wetting | 2.3 × 10−2 sec |

Raising bed temperature above boiling point of spray liquid may accelerate liquid removal. It may also cause rather rapid movement of particles on the surface (due to liquid boiling). This phenomenon is not included in the calculation.

Such systems and methods 1) perform precise and controlled deposition of a layer of build material, in some cases less than 50 micrometers thin and can do so at a rate of a few tens of centimeters per second; 2) facilitates reliable formation of thin powder films used in 3D printing; 3) can deposit small amounts of particles, small-sized particles and/or non-uniform particles; 4) increases part resolution by reducing interactions between a previously deposited layer and a currently deposited layer; 5) reduces part cost by using low-cost, small particles that are irregularly shaped and may not otherwise be usable in 3D printing operations. However, it is contemplated that the devices disclosed herein may address other matters and deficiencies in a number of technical areas.

What is claimed is:

1. A build material distribution device, comprising:
a rotating pressurized container to hold a suspension of a powdered build material in a liquid carrier, which powdered build material is to form a three-dimensional (3D) printed part;
a nozzle through which the suspension is ejected; and
a pressurizer coupled to the rotating pressurized container to eject the suspension through the nozzle.

2. The build material distribution device of claim 1, further comprising a slip seal disposed between the rotating pressurized container and the nozzle to mate the rotating pressurized container with a non-rotating nozzle.

3. The build material distribution device of claim 1, further comprising a disruptor disposed within at least one of the rotating pressurized container and the nozzle to introduce turbulence to the suspension.

4. The build material distribution device of claim 1, wherein the disruptor comprises at least one of:
a mixing paddle;
an ultrasound generator; and
a protrusion.

5. The build material distribution device of claim 1, wherein the pressurizer is at least one of:
a piston pump; and
a pressurized gas chamber fluidically connected to the rotating pressurized chamber.

6. The build material distribution device of claim 1, further comprising a pressure sensor disposed within the rotating pressurized chamber.

7. The build material distribution device of claim 1, wherein:
the build material distribution device forms a layer of suspension less than 50 micrometers thick; and
the powdered build material comprises particles having a diameter less than 20 micrometers.

8. A method, comprising:
introducing a suspension of a powdered build material in a liquid carrier into a pressurized container;
adjusting a pressure within the pressurized container to eject the suspension through a nozzle; and
moving a scanning carriage on which the pressurized container is disposed to deposit a layer of the suspension.

9. The method of claim 8, further comprising adjusting at least one of a pressure within the pressurized container, a temperature within the pressurized container, and an ejection speed of the suspension such that the suspension atomizes through the nozzle.

10. The method of claim 8, further comprising tuning a composition of the suspension such that predetermined deposition characteristics are generated.

11. The method of claim 8, further comprising reducing a pressure within the pressurized container to:
prevent leakage of suspension from the pressurized chamber when not printing; and
draw fluid into the pressurized chamber from at least one supply reservoir.

12. An additive manufacturing system, comprising:
a build material distribution device, comprising:
a pressurized container to hold a suspension of a powdered build material in a liquid carrier;
a nozzle through which the suspension is ejected;
a pressurizer coupled to the pressurized container to eject the suspension through the nozzle; and
a disruptor disposed within at least one of the pressurized container and nozzle to introduce turbulence to the suspension;
an agent distributor to selectively apply a solidifying agent to a layer of powdered build material to form a three-dimensional (3D) printed part; and
a controller to adjust operation of the build material distribution device and the agent distributor to print the 3D printed part.

13. The additive manufacturing system of claim 12, further comprising a heater to evaporate the liquid carrier from a surface on which the suspension is deposited to leave a layer of powdered build material without the liquid carrier.

14. The additive manufacturing system of claim 12, wherein:
the pressurized container rotates;
the nozzle does not rotate; and
the build material distributor further comprises a slip seal to provide a seal between the rotating pressurized container and the nozzle.

15. The additive manufacturing system of claim 14, further comprising:
a supply reservoir fluidly coupled to the rotating pressurized container; and
a slip seal per supply reservoir to allow stationary supply reservoirs to fluidly couple to the rotating pressurized container.
